(19) United States
(12) Patent Application Publication
(10) Pub. No.: US 2008/0135148 A1
(43) Pub. Date: Jun. 12, 2008

(54) Method for Enhancing Rubber Properties by Using Bunte Salt-Treated Fiber

(75) Inventors: Rabindra Nath Datta, Schalkhaar (NL); Pieter Jan De Lange, Westervoort (NL)

Correspondence Address: OLIFF & BERRIDGE, PLC, P.O. BOX 320850, ALEXANDRIA, VA, 22320-4850, US

(73) Assignee: TEIJIN TWARON B.V., AV Arnhem (NL)

(21) Appl. No.: 11/794,536

(22) PCT Filed: Feb. 14, 2006
(86) PCT No.: PCT/EP06/01318

§ 371 Date: Jul. 2, 2007

(30) Foreign Application Priority Data
Feb. 18, 2005 (EP) 05003521.1

(51) Int. Cl. B60C 1/00; C08C 19/20

(52) U.S. Cl. 152/209.4; 525/343; 152/537; 152/564

(57) ABSTRACT

The invention pertains to a fiber comprising 0.5-30 wt. % based on the weight of the fiber of a composition comprising:

a) a Bunte salt (A);
b) a polysulfide compound (B) comprising the moiety {S]ₙ— wherein n=2-6; and
c) sulfur or a sulfur donor (C).

Preferably the polysulfide compound has the formula:

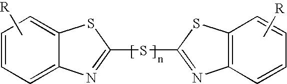

wherein n=2-6;

R is independently selected from hydrogen, halogen, nitro, hydroxyl, C1-C12 alkyl or alkoxyl or aralkyl;

The invention further relates to a vulcanization process for making a fiber-elastomer composition comprising the step of vulcanizing:

(a) 100 parts by weight of at least one natural or synthetic rubber;
(b) 0.1 to 25 parts by weight of an amount of sulfur and/or a sulfur donor, to provide the equivalent of 0.1 to 25 parts by weight of sulfur; and
(c) 0.1 to 20 parts by weight of said fiber.

The invention pertains to a fiber and to a method for obtaining said fiber for enhancing rubber properties. The invention further relates to a vulcanization process and to a fiber-elastomer composition obtainable by said process, and to a skim product, a tire and a tire tread comprising said fiber-elastomer composition.

In the tire and belt industries, among others, better mechanical, heat build up and hysteresis properties are being demanded. It has long been known that the mechanical properties of rubber can be improved by using a large amount of sulfur as a cross-linking agent to increase the crosslink density in vulcanized rubbers. However, the use of large amounts of sulfur suffers from the disadvantage of high heat generation that leads to a marked decrease in heat resistance and resistance to flex cracking, among other properties, in the final product.

In order to eliminate the foregoing disadvantage, it has been proposed to add treated chopped fiber, particularly treated with sulfur reagents to sulfur-vulcanization systems.

In JP 66008866 it has also been disclosed to use benzothiazole sulfide as adhesive promoters for polyamide fibers. None of these known methods, however, provide tires and belts having low crack growth, low modulus loss, and low tangent delta.

The present invention provides a solution to the above problems by the use of a novel class of treated chopped fibers in the sulfur vulcanization of rubbers and provides in fiber that solves a long-standing problem of reducing hysteresis and heat generation in rubber compositions.

To this end the invention relates to a fiber having enhanced rubber-properties when used in an elastomer, comprising 0.5-50 wt. % based on the weight of the fiber of a composition comprising:

a) a Bunte salt (A);
b) a polysulfide compound (B) comprising the moiety {S]ₙ— wherein n=2-6; and
c) sulfur or a sulfur donor (C).

The polysulfide compound is not critical. In fact any polysulfide having the group {S]ₙ— wherein n=2-6 will have the beneficial properties of the invention. Examples of polysulfides are, for instance:

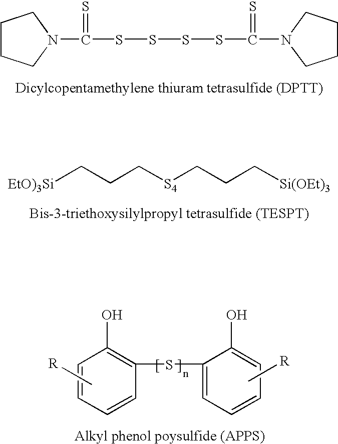

More preferably, the composition comprises:

a) a Bunte salt (A);
b) a polysulfide compound (B) of the formula:

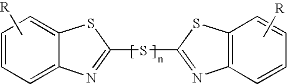

wherein n=2-6;
R is independently selected from hydrogen, halogen, nitro, hydroxyl, C1-C12 alkyl or alkoxyl or aralkyl; and
c) sulfur or a sulfur donor (C).
The treatment of the fiber is based on the above Bunte salt and polysulfide compound sulfur chemicals, preferably disodium hexamethylene-1,6-bis(thiosulfate) dihydrate, 2-mercaptobenzothiazyl disulfide, which chemicals further contain sulfur or a sulfur donor. After treatment the fibers may be chopped to appropriate length, which can suitably used in rubber compounds, or chopped fiber may be treated by the above sulfur chemicals.

A particularly useful sulfur chemical of the present invention is a mixture consisting of:

i. a Bunte salt having the formula (H)_{m′}—(R¹—S—SO₃⁻M⁺)ₘ.xH₂O;
ii. a polysulfide compound (B) of the formula:

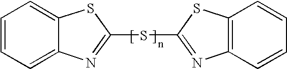

iii. and sulfur or a sulfur donor;
wherein n is an integer selected from 2 to 6, m is 1 or 2, m′ is 0 or 1, and m+m′=2; x is 0-3, M is selected from Na, K, Li, ½ Ca, ½ Mg, and ⅓ Al and R¹ is selected from C1-C12 alkylene, C1-C12 alkoxylene, and C7-C12 aralkylene.

Most preferred Bunte salt has m is 2, m′ is 0, M is Na, and R1 is C1-C12 alkylene, such as hexylene (hexamethylene). Such Bunte salt may be a dihydrate.

The composition amounts 0.5-30 wt. % based on the weight of the fiber, preferably 1-20 wt. %, more preferably 2-8 wt. %.

The treatment of the fibers can be carried out in a mixture of disodium hexamethylene-1,6-bis(thiosulfate) dehydrate, 2-mercaptobenzothiazyl disulfide (MBTS), and sulfur or sulfur-containing chemicals. 2-Mercapto-benzothiazyl disulfide can be replaced by other benzothiazole derivatives.

Preferred compositions comprise 0.25-25 wt. %, more preferably 2-10 wt. % component A, 0.01-15 wt. %, more preferably 0.1-3 wt. % component B, and 0.001-10 wt. %, more preferably 0.01-2.5 wt. % sulfur, based on the weight of the fiber. The amount of sulfur is the amount of sulfur as used as such, or the amount of sulfur that is generated if a sulfur donor is used.

Preferably, the fiber is treated with a sizing. This sizing can be combined with the sulfur chemicals or can be applied in a separate process step. Suitable examples of sizings are sulfonated polyester resins and polyurethane dispersions.

In another aspect the invention relates to a rubber composition which is the vulcanization reaction product of a rubber, sulfur and optionally sulfur donor, and said treated fiber, which preferably is a chopped fiber. The treated fiber acts as a modulus enhancer, strength improver, as well lowers hysteresis. Also disclosed is a vulcanization process carried out in the presence of the treated fibers and the use of these treated fibers in the sulfur-vulcanization of rubbers.

In addition, the present invention relates to a vulcanization process carried out in the presence of the treated fibers and the use of these treated fibers in the sulfur-vulcanization of rubbers. Further, the invention also encompasses rubber products which comprise at least some rubber which has been vulcanized, preferably vulcanized with sulfur, in the presence of said treated fibers.

The present invention provides excellent hysteresis behavior as well as improvements in several rubber properties without having a significant adverse effect on the remaining properties, when compared with similar sulfur-vulcanization systems without any treated fiber.

The present invention is applicable to all natural and synthetic rubbers. Examples of such rubbers include, but are not limited to, natural rubber, styrene-butadiene rubber, butadiene rubber, isoprene rubber, acrylonitrile-butadiene rubber, chloroprene rubber, isopreneisobutylene rubber, brominated isoprene-isobutylene rubber, chlorinated isoprene-isobutylene rubber, ethylene-propylene-diene terpolymers, as well as combinations of two or more of these rubbers and combinations of one or more of these rubbers with other rubbers and/or thermoplastics.

Sulfur, optionally together with sulfur donors, provides the required level of sulfur during the vulcanization process. Examples of sulfur which may be used in the vulcanization process include various types of sulfur such as powdered sulfur, precipitated sulfur and insoluble sulfur. Examples of sulfur donors include, but are not limited to, tetramethylthiuram disulfide, tetraethyl-thiuram disulfide, tetrabutylthiuram disulfide, dipentamethylene thiuram hexasulfide, dipentamethylene thiuram tetrasulfide, dithiodimorpholine, and mixtures thereof.

Sulfur donors may be used instead or in addition to the sulfur. Herein the term “sulfur” shall further also include the mixture of sulfur and sulfur donor(s). Further, references to the quantity of sulfur employed in the vulcanization process, when applied to sulfur donors, mean a quantity of sulfur donor which is required to provide the equivalent amount of sulfur that is specified.

More particularly, the present invention relates to a sulfur-vulcanized rubber composition which comprises the vulcanization reaction product of: (a) 100 parts by weight of at least one natural or synthetic rubber; (b) 0.1 to 25 parts by weight of an amount of sulfur, or sulfur and/or a sulfur donor, to provide the equivalent of 0.1 to 25 parts by weight of sulfur; and (c) 0.1 to 20 parts by weight of a treated fiber, preferably chopped fiber.

The treated fiber of the present invention is based on natural and synthetic yarns. Examples of such yarns include, but not limited to, aramid, such as para-aramid, polyamide, polyester, cellulose, such as, rayon, glass, and carbon as well as combinations of two or more of these yarns.

Most preferably the fiber is poly(para-phenylene-terephthalamide), which is commercially available under the trade name Twaron®, or co-poly-(para-phenylene/3,4′-oxydiphenylene terephthalamide, which is commercially available under the trade name Technora®.

The amount of sulfur to be compounded with the rubber is, based on 100 parts of rubber, usually 0.1 to 25 parts by weight, and more preferably 0.2 to 8 parts by weight. The amount of sulfur donor to be compounded with the rubber is an amount to provide an equivalent amount of sulfur, i.e. an amount which gives the same amount of sulfur, as if sulfur itself were used. The amount of treated chopped fiber to be compounded with the rubber is, based on 100 parts of rubber, 0.1 to 25 parts by weight, and more preferably 0.2 to 10.0 parts by weight, and most preferably 0.5 to 5 parts by weight. These ingredients may be employed as a pre-mix, or added simultaneously or separately, and they may be added together with other rubber compounding ingredients as well. In most circumstances it is also desirable to have a vulcanization accelerator in the rubber compound. Conventional, known vulcanization accelerators may be employed. The preferred vulcanization accelerators include mercaptobenzothiazole, 2,2′-mercaptobenzothiazole disulfide, sulfenamide accelerators including N-cyclohexyl-2-benzothiazole sulfenamide, N-tert-butyl-2-benzothiazole sulfenamide, N,N-dicyclohexyl-2-benzothiazole sulfenamide, and 2-(morpholinothio)benzothiazole; thio-phosphoric acid derivative accelerators, thiurams, dithiocarbamates, diphenyl guanidine, diorthotolyl guanidine, dithiocarbamylsulfenamides, xanthates, triazine accelerators and mixtures thereof.

When the vulcanization accelerator is employed, quantities of from 0.1 to 8 parts by weight, based on 100 parts by weight of rubber composition, are used. More preferably, the vulcanization accelerator comprises 0.3 to 4.0 parts by weight, based on 100 parts by weight of rubber. Other conventional rubber additives may also be employed in their usual amounts. For example, reinforcing agent such as carbon black, silica, clay, whiting and other mineral fillers, as well as mixtures of fillers, may be included in the rubber composition. Other additives such as process oils, tackifiers, waxes, antioxidants, antiozonants, pigments, resins, plasticizers, process aids, factice, compounding agents and activators such as stearic acid and zinc oxide may be included in conventional, known amounts. For a more complete listing of rubber additives which may be used in combination with the present invention see, W. Hofmann, “Rubber Technology Handbook, Chapter 4, Rubber Chemicals and Additives, pp. 217-353, Hanser Publishers, Munich 1989.

Further, scorch retarders such as phthalic anhydride, pyromellitic anhydride, benzene hexacarboxylic trianhydride, 4-methylphthalic anhydride, trimellitic anhydride, 4-chlorophthalic anhydride, N-cyclohexyl-thiophthalimide, salicylic acid, benzoic acid, maleic anhydride and N-nitrosodiphenylamine may also be included in the rubber composition in conventional, known amounts. Finally, in specific applications it may also be desirable to include steel-cord adhesion promoters such as cobalt salts and dithiosulfates in conventional, known quantities.

The process is carried out at a temperature of 110-220° C. over a period of up to 24 hours. More preferably, the process is carried out at a temperature of 120-190° C. over a period of up to 8 hours in the presence of 0.1 to 20 parts by weight of treated fiber or chopped fiber. Even more preferable is the use of 0.2-5 parts by weight of treated chopped fiber. All of the additives mentioned above with respect to the rubber composition may also be present during the vulcanization process of the invention.

In a more preferred embodiment of the vulcanization process, the vulcanization is carried out at a temperature of 120-190° C. over a period of up to 8 hours and in the presence of 0.1 to 8 parts by weight, based on 100 parts by weight of rubber, of at least one vulcanization accelerator. In another preferred embodiment of the vulcanization process, the treated fiber is treated with a mixture of sulfur chemicals.

The present invention also includes articles of manufacture, such as skim products, tires, tire treads, tire undertreads, or belts, which comprise sulfur-vulcanized rubber which is vulcanized in the presence of the treated fiber of the present invention.

The invention is further illustrated by the following examples which are not to be construed as limiting the invention in any way.

### EXPERIMENTAL METHODS

Compounding, Vulcanization and Characterization of Compounds

In the following examples, rubber compounding, vulcanization and testing was carried out according to standard methods except as otherwise stated: Base compounds were mixed in a Farrel Bridge™ BR 1.6 liter Banbury type internal mixer (preheating at 500° C., rotor speed 77 rpm, mixing time 6 min with full cooling).

Vulcanization ingredients were added to the compounds on a Schwabenthan PolyMix™ 150L two-roll mill (friction 1:1.22, temperature 700° C., 3 min).

Cure characteristics were determined using a Monsanto™ rheometer MDR 2000E (arc 0.50°) according to ISO 6502/1999. Delta S is defined as the extent of crosslinking and is derived from subtraction of lowest torque (ML) from highest torque (MH).

Sheets and test specimens were vulcanized by compression molding in a Fontyne™ TP-400 press.

Tensile measurements were carried out using a Zwick™ 1445 tensile tester (ISO-2 dumbbells, tensile properties according to ASTM D 412-87, tear strength according to ASTM D 624-86).

Abrasion was determined using a Zwick abrasion tester as volume loss per 40 m path traveled (DIN 53516).

De Mattia crack growth measurements were done following the ISO 132/1999 procedure.

Heat build-up and compression set after dynamic loading were determined using a Goodrich™ Flexometer (load 1 MPa, stroke 0.445 cm, frequency 30 Hz, start temperature 100° C., running time 120 min or till blow out; ASTM D 623-78).

Dynamic mechanical analyses, for example loss modulus and tangent delta (Table 5) were carried out using an Eplexor™ Dynamic Mechanical Analyzer (pre-strain 10%, frequency 15 Hz, ASTM D 2231).

The treatment of the fibres was done in the following way: Standard para-aramid yarn (Twaron or Technora) was treated with a mixture of sulfur chemicals in toluene solvent, by using a standard slit applicator. After application, the yarn was dried for 12 seconds at 190° C. by using a tube oven. The treated yarn was chopped into 3 mm by using a standard cutting machine.

The treated chopped fibers (3 mm) on p-aramid matrices were the following:

### Example 1

| | | ratio | | Ingredients |
|---|---|---|---|---|
| fiber | treatment | (wt. %) | remark | code |
| Twaron | chopped fibers | | comparison | T1 |
| Twaron | dipped chopped | | comparison | T2 |
| | fibers | | | |
| Twaron | 6% HTS/MBTS | 4:2 | comparison | T3 |
| Twaron | 5% HTS/sulfur | 4:1 | comparison | T4 |
| Twaron | 4% HTS | | comparison | T5 |
| Twaron | 3% MBTS/sulfur | 4:2 | comparison | T6 |
| Twaron | 7% HTS/MBTS/ | 4:2:1 | invention | T7 |
| | sulfur | | | |
| Twaron | 4.3% HTS/MBTS/ | 4:0.2:0.1 | invention | T8 |
| | sulfur | | | |
| Technora | 7% HTS/MBTS/ | 4:2:1 | invention | T9 |
| | sulfur | | | |

The accelerator employed was N-cyclohexyl-2-benzothiazole sulfen-amide (CBS). Details of the formulations are listed in Table 1.

TABLE 1
Formulations (fibers)

| | Experiment | | | | | | | | | | |
|---|---|---|---|---|---|---|---|---|---|---|---|
| Ingredients | A | B | C | D | E | F | G | H | 1 | 2 | 3 |
| NR, SMR 10 | 80 | 80 | 80 | 80 | 80 | 80 | 80 | 80 | 80 | 80 | 80 |
| BR, Buna CB24 | 20 | 20 | 20 | 20 | 20 | 20 | 20 | 20 | 20 | 20 | 20 |
| Black, N-339 | 57 | 55 | 55 | 55 | 55 | 55 | 55 | 55 | 55 | 55 | 55 |
| Zinc oxide | 5 | 5 | 5 | 5 | 5 | 5 | 5 | 5 | 5 | 5 | 5 |
| Stearic acid | 2 | 2 | 2 | 2 | 2 | 2 | 2 | 2 | 2 | 2 | 2 |
| Aromatic oil | 8 | 8 | 8 | 8 | 8 | 8 | 8 | 8 | 8 | 8 | 8 |
| Antiozonant | 2 | 2 | 2 | 2 | 2 | 2 | 2 | 2 | 2 | 2 | 2 |
| 6PPD | | | | | | | | | | | |
| Antioxidant | 1 | 1 | 1 | 1 | 1 | 1 | 1 | 1 | 1 | 1 | 1 |
| TMQ | | | | | | | | | | | |
| Accelerator CBS | 1.5 | 1.5 | 1.5 | 1.5 | 1.5 | 1.5 | 1.5 | 1.5 | 1.5 | 1.5 | 1.5 |
| Sulfur | 1.5 | 1.5 | 1.5 | 1.5 | 1.5 | 1.5 | 1.5 | 1.5 | 1.5 | 1.5 | 1.5 |
| T1 | 0 | 0 | 1.5 | 0 | 0 | 0 | 0 | 0 | 0 | 0 | 0 |
| T2 | 0 | 0 | 0 | 1.5 | 0 | 0 | 0 | 0 | 0 | 0 | 0 |
| T3 | 0 | 0 | 0 | 0 | 1.5 | 0 | 0 | 0 | 0 | 0 | 0 |
| T4 | 0 | 0 | 0 | 0 | 0 | 1.5 | 0 | 0 | 0 | 0 | 0 |
| T5 | 0 | 0 | 0 | 0 | 0 | 0 | 1.5 | 0 | 0 | 0 | 0 |
| T6 | 0 | 0 | 0 | 0 | 0 | 0 | 0 | 1.5 | 0 | 0 | 0 |
| T7 | 0 | 0 | 0 | 0 | 0 | 0 | 0 | 0 | 1.5 | 0 | 0 |
| T8 | 0 | 0 | 0 | 0 | 0 | 0 | 0 | 0 | 0 | 1.5 | 0 |
| T9 | 0 | 0 | 0 | 0 | 0 | 0 | 0 | 0 | 0 | 0 | 1.5 |

NR is natural rubber,
BR polybutadiene rubber,
6PPD N-1,3-dimethylbutyl-N′-phenyl-p-phenylediamine antidegradant,
TMQ is polymerized 2,2,4-trimethyl-1,2-dihydoquinoline antioxidant,
CBS is N-cyclohexyl benzothiazyl sulfonamide,
HTS is disodium hexamethylene 1,6-bis(thiosulfate)dehydrate (Bunte salt) and
MBTS is 2-mercaptobenzothiazyl disulfide

The vulcanized rubbers listed in Table 1 were then tested according to relevant ASTM/ISO norms. A and B are control experiments, C—H are comparison experiments, and 1-3 are experiments according to the invention. The results are given in Tables 2-5.

TABLE 2
Effect of the mixes at 150° C. on cure data.

| | Experiment | | | | | | | | | | |
|---|---|---|---|---|---|---|---|---|---|---|---|
| | A | B | C | D | E | F | G | H | 1 | 2 | 3 |
| Delta S, Nm | 1.74 | 1.72 | 1.77 | 1.78 | 1.78 | 1.75 | 1.75 | 1.75 | 2.10 | 1.88 | 2.10 |

The data of Table 2 show that the fibers according to the invention (wherein all three ingredients are present, mixes 1, 2, and 3) show the highest reinforcement as evidenced from the delta torque data.

TABLE 3
Evaluation of treated fibers for improvement in mechanical properties

| | Experiment | | | | | | | | | | |
|---|---|---|---|---|---|---|---|---|---|---|---|
| | A | B | C | D | E | F | G | H | 1 | 2 | 3 |
| modulus, 300% | 15.4 | 14.0 | 15.3 | 15.8 | 14.2 | 14.4 | 14.4 | 13.9 | 16.1 | 16.1 | 16.2 |
| tear strength | 128 | 130 | 145 | 145 | 115 | 115 | 110 | 125 | 165 | 165 | 160 |
| kN/mm | | | | | | | | | | | |
| abrasion | 120 | 140 | 100 | 100 | 195 | 105 | 110 | 105 | 90 | 90 | 85 |
| resistance mm³ | | | | | | | | | | | |

It is clear from the data depicted in Table 3 that the fibers of the invention have better modulus, tear strength and abrasion resistance.

TABLE 4
Evaluation of fibers for enhancement of crack growth resistance

| De Mattia crack | Experiment | | | | | | | | | | |
|---|---|---|---|---|---|---|---|---|---|---|---|
| growth, Kc | A | B | C | D | E | F | G | H | 1 | 2 | 3 |
| L/L + 2 | 65 | 40 | 120 | 130 | 120 | 120 | 120 | 120 | 200 | 150 | 200 |
| L + 2/L + 6 | 420 | 370 | 510 | 520 | 500 | 520 | 510 | 510 | 800 | 650 | 1000 |
| L + 6/L + 10 | 720 | 650 | 850 | 900 | 900 | 880 | 850 | 890 | 1800 | 1500 | 2000 |

The advantages in blow out times as well as hysteresis (Tangent delta) are shown Table 5.

TABLE 5
Evaluation of improvement in dynamic mechanical properties

| | Experiment | | | | | | | | | | |
|---|---|---|---|---|---|---|---|---|---|---|---|
| | A | B | C | D | E | F | G | H | 1 | 2 | 3 |
| temperature | 35.1 | 32.1 | 27.9 | 28.1 | 27.3 | 27.1 | 26.5 | 27.4 | 25.1 | 24.5 | 24.2 |
| rise ° C. | | | | | | | | | | | |
| blow out time | 35 | 38 | 45 | 43 | 35 | 37 | 36 | 37 | 57 | 57 | >60 |
| min | | | | | | | | | | | |
| loss modulus | 1.12 | 1.08 | 1.05 | 1.05 | 1.06 | 1.09 | 1.08 | 1.11 | 0.948 | 0.946 | 0.989 |
| MPa | | | | | | | | | | | |
| Tangent delta | 0.150 | 0.145 | 0.135 | 0.133 | 0.148 | 0.152 | 0.148 | 0.150 | 0.120 | 0.120 | 0.123 |

### Example 2

In this series various combinations with other polysulfides (such as DPTT, ESPT, and APPS) were evaluated.

The pellets based on p-aramid matrices were the following:

TABLE 6

| | | ratio | | Ingredients |
|---|---|---|---|---|
| fiber | treatment | (wt. %) | remark | code |
| Twaron | 3% APPS/S | 2:1 | comparison | K1 |
| Twaron | 3% DPTT/S | 2:1 | comparison | K2 |
| Twaron | 3% TESPT/S | 2:1 | comparison | K3 |
| Twaron | 3% S | | comparison | K4 |
| Twaron | 3% HTS | | comparison | K5 |
| Twaron | 3.25 HTS/APPS/S | 3:0.17:0.077 | invention | K6 |
| Twaron | 3.25% HTS/DPTT/S | 3:0.17:0.085 | invention | K7 |
| Twaron | 3.33% HTS/TESPT/ | 3:0.25:0.082 | invention | K8 |
| | S | | | |

The rubber formulations using the material as described in Table 6 are shown in Table 7.

TABLE 7
Formulations (pellets)

| | Experiment | | | | | | | | | |
|---|---|---|---|---|---|---|---|---|---|---|
| Ingredients | A | B | P | Q | R | S | T | 4 | 5 | 6 |
| NR, SMR 10 | 80 | 80 | 80 | 80 | 80 | 80 | 80 | 80 | 80 | 80 |
| BR, Buna CB24 | 20 | 20 | 20 | 20 | 20 | 20 | 20 | 20 | 20 | 20 |
| Black, N-339 | 57 | 55 | 55 | 55 | 55 | 55 | 55 | 55 | 55 | 55 |
| Zinc oxide | 5 | 5 | 5 | 5 | 5 | 5 | 5 | 5 | 5 | 5 |
| Stearic acid | 2 | 2 | 2 | 2 | 2 | 2 | 2 | 2 | 2 | 2 |
| Aromatic oil | 8 | 8 | 8 | 8 | 8 | 8 | 8 | 8 | 8 | 8 |
| Antiozonant | 2 | 2 | 2 | 2 | 2 | 2 | 2 | 2 | 2 | 2 |
| 6PPD | | | | | | | | | | |
| Antioxidant | 1 | 1 | 1 | 1 | 1 | 1 | 1 | 1 | 1 | 1 |
| TMQ | | | | | | | | | | |
| Accelerator CBS | 1.5 | 1.5 | 1.5 | 1.5 | 1.5 | 1.5 | 1.5 | 1.5 | 1.5 | 1.5 |
| Sulfur | 1.5 | 1.5 | 1.5 | 1.5 | 1.5 | 1.5 | 1.5 | 1.5 | 1.5 | 1.5 |
| K1 | 0 | 0 | 3.0 | 0 | 0 | 0 | 0 | 0 | 0 | 0 |
| K2 | 0 | 0 | 0 | 3.0 | 0 | 0 | 0 | 0 | 0 | 0 |
| K3 | 0 | 0 | 0 | 0 | 3.0 | 0 | 0 | 0 | 0 | 0 |
| K4 | 0 | 0 | 0 | 0 | 0 | 3.0 | 0 | 0 | 0 | 0 |
| K5 | 0 | 0 | 0 | 0 | 0 | 0 | 3.0 | 0 | 0 | 0 |
| K6 | 0 | 0 | 0 | 0 | 0 | 0 | 0 | 3.0 | 0 | 0 |
| K7 | 0 | 0 | 0 | 0 | 0 | 0 | 0 | 0 | 3.0 | 0 |
| K8 | 0 | 0 | 0 | 0 | 0 | 0 | 0 | 0 | 0 | 3.0 |

The vulcanized rubbers listed in Table 7 were tested according to relevant ASTM/ISO norms. A and B are control experiments, P-T are comparison experiments, and 4-6 are experiments according to the invention. The results are given in Tables 8-10.

TABLE 8
Effect of the mixes at 150° C. on cure data.

| | Experiment | | | | | | | | | |
|---|---|---|---|---|---|---|---|---|---|---|
| | A | B | P | Q | R | S | T | 4 | 5 | 6 |
| Delta S, Nm | 1.74 | 1.72 | 1.72 | 1.75 | 1.78 | 1.75 | 1.76 | 2.06 | 1.98 | 2.00 |

The data in Table 8 show that the fibers according to the invention (wherein all three ingredients are present, mixes 4, 5 and 6) show the highest reinforcement as demonstrated by delta torque values.

TABLE 9
Evaluation of treated fibers for the improvement in mechanical properties

| | Experiment | | | | | | | | | |
|---|---|---|---|---|---|---|---|---|---|---|
| | A | B | P | Q | R | S | T | 4 | 5 | 6 |
| Modulus, 300% | 15.4 | 14.0 | 14.4 | 14.7 | 14.7 | 14.4 | 14.1 | 15.5 | 15.1 | 15.5 |
| tear strength | 128 | 130 | 130 | 135 | 120 | 125 | 120 | 165 | 170 | 170 |
| kN/mm | | | | | | | | | | |
| Abrasion | 120 | 140 | 120 | 115 | 125 | 120 | 115 | 90 | 90 | 90 |
| resistance mm³ | | | | | | | | | | |

It is clear from the data depicted in Table 9 that the fibers of the invention have better modulus, tear strength and abrasion resistance.

The advantages in the hysteresis (tangent delta) are shown in Table 10.

TABLE 10
Evaluation of improvement in dynamic mechanical properties

| | Experiment | | | | | | | | | |
|---|---|---|---|---|---|---|---|---|---|---|
| | A | B | P | Q | R | S | T | 4 | 5 | 6 |
| Storage | 7.46 | 7.44 | 7.33 | 7.16 | 7.71 | 7.39 | 7.55 | 7.45 | 7.41 | 7.99 |
| modulus, MPa | | | | | | | | | | |
| loss modulus | 1.12 | 1.08 | 0.98 | 0.95 | 1.06 | 1.09 | 1.11 | 0.93 | 0.91 | 0.96 |
| MPa | | | | | | | | | | |
| Tangent delta | 0.150 | 0.145 | 0.134 | 0.132 | 0.141 | 0.142 | 0.147 | 0.125 | 0.123 | 0.121 |

1. A fiber comprising 0.5-30 wt. % based on the weight of the fiber of a composition comprising:
a) a Bunte salt (A);
b) a polysulfide compound (B) comprising the moiety —{S]ₙ— wherein n=2-6; and
c) sulfur or a sulfur donor (C).

2. The fiber of claim 1 wherein the polysulfide compound (B) has the formula: 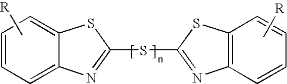
wherein n=2-6;
R is independently selected from hydrogen, halogen, nitro, hydroxyl, C1-C12 alkyl or alkoxyl or aralkyl.

3. The fiber of claim 1 wherein the composition comprises 0.25-25 wt. % Bunte salt (A), 0.15-15 wt. % polysulfide compound (B), and 0.001-10 wt. % sulfur, based on the weight of the fiber.

4. The fiber of claim 1 wherein the Bunte salt has the formula
(H)_{m′}—(R—S—SO₃⁻M⁺)ₘ.xH₂O, wherein M is selected from Na, K, Li, ½ Ca, ½ Mg, and ⅓ Al, and R¹ is selected from alkylene, arylene, aralkylene, alkylarylene, m is 1 or 2, m′ is 0 or l, m+m′=2; and x is 0-3.

5. The fiber of claim 4 wherein M is Na, x is 0-2, R¹ is C1-C12 alkylene, m is 2 and m′ is 0.

6. The fiber of claim 1 wherein the fiber is a chopped fiber.

7. The fiber of claim 1 wherein the fiber is selected from aramid, polyester, polyamide, cellulose, glass, and carbon.

8. The fiber of claim 7 wherein the fiber is a poly(p-phenylene-terephthalamide) or a co-poly-(paraphenylene/3,4′-oxydiphenylene terephthalamide fiber.

9. A method for obtaining a fiber with enhanced rubber properties by adding to the fiber 0.5-30 wt. % based on the weight of the fiber of a composition comprising:
a) a Bunte salt (A);
b) a polysulfide compound (B) comprising the moiety —{S]ₙ— wherein n=2-6; and
c) sulfur or a sulfur donor (C).

10. The method according to claim 9 wherein the fiber is treated with a sizing.

11. A vulcanization process for making a fiber-elastomer composition comprising the step of vulcanizing:
(a) 100 parts by weight of at least one natural or synthetic rubber;
(b) 0.1 to 25 parts by weight of an amount of sulfur and/or a sulfur donor, to provide the equivalent of 0.1 to 25 parts by weight of sulfur; and
(c) 0.1 to 20 parts by weight of the fiber of claim 1.

12. A fiber-elastomer composition obtainable by the method according to claim 11.

13. A skim product comprising the composition of claim 11 and optionally common skim additives.

14. A tire comprising the composition of claim 11 and/or the skim product comprising the composition made by the vulcanization process comprising the step of vulcanizing:
(a) 100 parts by weight of at least one natural or synthetic rubber;
(b) 0.1 to 25 parts by weight of an amount of sulfur and/or a sulfur donor, to provide the equivalent of 0.1 to 25 parts by weight of sulfur; and
(c) 0.1 to 20 parts by weight of the fiber comprising 0.5-30 wt. % based on the weight of the fiber of a composition comprising:
a) a Bunte salt (A);
b) a polysulfide compound (B) comprising the moiety —{S]ₙ— wherein n=2-6; and
c) sulfur or a sulfur donor (C).

15. A tire tread, undertread, or belt comprising the composition of claim 11 and/or the skim product comprising the composition made by the vulcanization process comprising the step of vulcanizing:
(a) 100 parts by weight of at least one natural or synthetic rubber;
(b) 0.1 to 25 parts by weight of an amount of sulfur and/or a sulfur donor, to provide the equivalent of 0.1 to 25 parts by weight of sulfur; and
(c) 0.1 to 20 parts by weight of the fiber comprising 0.5-30 wt. % based on the weight of the fiber of a composition comprising:
a) a Bunte salt (A);
b) a polysulfide compound (B) comprising the moiety —{S]ₙ— wherein n=2-6; and
c) sulfur or a sulfur donor (C).
